(19) United States
(12) Patent Application Publication
(10) Pub. No.: US 2011/0237437 A1
(43) Pub. Date: Sep. 29, 2011

(54) Herbicidal Treatment Compositions and Methods for Improved Control of Undesired Vegetation in Rice Crops

(75) Inventors: Tak Wai Cheung, Yuma, AZ (US); Sergio Camparini, Yuma, AZ (US); Wallace Keith Majure, West Monroe, LA (US); Kevin Wayne Stewart, CollIerville, TN (US); Sandra Alcaraz, Yuma, AZ (US); Charles Paul Grasso, Yuma, AZ (US)

(73) Assignee: Gowan Comercio Internacional E Servicos L, Madeira (PT)

(21) Appl. No.: 13/000,559

(22) PCT Filed: Jul. 10, 2009
(86) PCT No.: PCT/US2009/050195

§ 371 Date: Jun. 8, 2011

Related U.S. Application Data
(60) Provisional application No. 61/081,123, filed on Jul. 16, 2008.

(51) Int. Cl. A01N 43/54; A01P 13/02

(52) U.S. Cl. 504/243

(57) ABSTRACT

Provided are improved agricultural processes for the improved cultivation of crops of rice varieties modified to be tolerant to imparted with resistance to imidazolinone type herbicides wherein the crops are treated to control undesired vegetative growth using a halosulfuron methyl herbicidal composition to provide improved herbicidal efficacy. Also provided are compositions useful in the improved agricultural processes, as well as herbicidal treatment regimens. Unexpectedly high rates of efficacy against one or more of Sesbania hemp (Sesbania exaltata), Indian Joint vetch (Aeschynomene indica), and Alligator weed (Alternanthera philoxeroides) amongst rice crops are disclosed.

Broadly the present invention relates to an improved process for the control of undesired vegetative growth amongst rice crops.

In order to improve the crop yields of desirable crops which are used for foodstuffs, human or animal consumption, or other purposes such as biofuels it has long been the practice in the fields to utilize on the one hand a broad spectrum type of herbicide or compositions which are effective at controlling or eradicating the growth of undesired vegetation, i.e., weeds, within fields or plots having were in such crops are grown and ultimately harvested, and on the other hand to grow such crops from seeds, plants, or cultivars which haven't been genetically modified, crossbred, or otherwise altered in order to present specific resistance to, alternately also referred to as “tolerance to” specific classes of herbicides. Crop yields are expected to be best when a specific type or class of seed, plants, or cultivar having a specific tolerance is treated by a herbicide of that type. In such a manner, undesired vegetation growing among the plants of the crop can be controlled and or eradicated by use of the specific herbicide to which the seed, plants or cultivars exhibits resistance thereto. This is advantageous in that the farmer or other producer is not required to necessarily use two or more types of different herbicidal compounds or compositions, or to prepare multiple herbicidal preparations which may require separate applications to a crop either pre-planting, or post emergence of such herbicidal preparations to the crop.

A particularly popular and successful class of herbicide compounds are those based on glyphosates, with the most salient commercial product being commercially sold as “Roundup®” (ex. Monsanto). This glyphosate type herbicide has been known for many years to be highly effective in the control and eradication of undesired vegetative growth in crops and has found widespread acceptance and use. Such widespread acceptance and use is further bolstered by the fact that the supplier of Roundup® also has developed various seed lines for crops, such as soybeans, which have been genetically modified, crossbred or otherwise altered in order to exhibit resistance to the Roundup® line of herbicides, viz, are “tolerant to” Roundup®. The combined use of both Roundup® herbicides in conjunction with specific seed lines which are tolerant to Roundup® has led to improved crop yields, and has reduced the amount and/or the frequency of the application of herbicidal treatment compositions to crops as the application of glyphosate based herbicidal preparations is usually successful in eradicating weeds while at the same time minimizing damage to the crop.

Notwithstanding the popularity of the above, many other classes of herbicides are also known and similarly, various suppliers have produced and made commercially available various seed lines, plants or cultivars for crops which exhibit tolerance to and/or resistance to one or more of specific classes of herbicides. For example, varieties of rice have been developed which have been genetically modified, crossbred or otherwise altered in order to exhibit resistance to the class of sulfonylurea based herbicides and imidazolinone class of herbicides. Such varieties are in widespread use, as they are found to be very effectively treated by the use of sulfonylurea or imidazolinone based herbicidal treatment preparations which are known to be effective in controlling the growth of undesired vegetation within the rice crop, while at the same time not unduly affecting the vitality of the rice crop itself or its rice yield, and frequently improving yields and or quality.

An exemplary variety of rice which have been relatively recently introduced into widespread planting and cultivation in North America as well as in other geographic regions is often referred to as either Newpath® or Clearfield® rice, which rice variety is modified to be tolerant to imidazolinone type herbicides. Several commercially available imidazolinone type herbicides are currently marketed for use on such rice varieties, and include Newpath® (ex. BASF), and Thunder® (ex. Albaugh, Inc.) all contain the active ingredient imazethapyr, a member of the imidazolinone class of herbicides While their use is found to be effective in treating both Newpath and Clearfield rice variety crops, nonetheless there exists a real and pressing need for further improvements in the control of undesired vegetative growth in such rice varieties, particularly improvements in herbicidal treatment compositions and/or treatment regimens useful with such rice variety crops.

Surprisingly it has been found that the incorporation of halosulfuron-methyl, from the sulfonyl urea class of herbicides in treatment regimens used to control undesired vegetation in the production of rice results in greatly improved, synergistic control of one or more pernicious vegetative growths which are troublesome to eradicate utilizing normal herbicidal treatment regimens, namely one or more of Sesbania hemp (Sesbania exaltata), Indian Joint vetch (Aeschynomene indica), and Alligator weed (Alternanthera philoxeroides). The inventors have surprisingly discovered that the use of halosulfuron-methyl provided an unexpectedly increased improvement in the control of (in increasing order of efficacy) Alligator weed, Indian Joint Vetch and Sesbania hemp. Such surprising results suggest a synergistic effect. Such a behavior has been observed with a commercially available compound marketed under the tradename PERMIT, (ex. Gowan Co., Yuma, Ariz.) but while not wishing to be bound by the following it is believed that such behavior might also be observed with other specific sulfonylurea herbicide compounds.

Accordingly, in one aspect of the present invention, the present inventors provide improved agricultural processes for the improved cultivation of crops of rice, especially preferably crops of rice varieties modified to be tolerant to imparted with resistance to imidazolinone type herbicides, wherein the crops are treated to control undesired vegetative growth using a sulfonylurea based herbicide, especially preferably a halosulfuron-methyl herbicidal composition to provide improved herbicidal efficacy.

According to a second aspect of the invention there are provided new regimens for the herbicidal treatment of crops of rice, especially preferably crops of rice varieties modified to be tolerant to imparted with resistance to imidazolinone type herbicides in order to provide improved undesired vegetative growth within the planted rice crop.

According to a third aspect of the invention there are provided new regimens according to the second aspect, wherein improved control and/or improved eradication of one or more of: of Sesbania hemp (Sesbania exaltata), Indian Joint vetch (Aeschynomene indica), and Alligator weed (Alternanthera philoxeroides)—is provided.

According to a fourth aspect of the invention, there are provided herbicidal compositions which are particularly useful in the treatment of crops of rice, especially preferably crops of rice varieties modified to be tolerant to imparted with resistance to imidazolinone type herbicides which are useful in the agricultural processes according to the first aspect, as well as being useful in the regimens according to the second and third aspects of the invention.

According to a fifth aspect of the invention there are provided herbidical compositions which comprise both an imidazolinone type herbicide, e.g., NEWPATH, and a sulfonylurea based herbicide, especially preferably a halosulfuron-methyl herbicide, e.g., PERMIT, which provides a synergistically improved benefit in the control of undesired vegetative growth in rice crops, especially preferably crops of rice varieties modified to be tolerant to imparted with resistance to imidazolinone type herbicides in order to provide improved undesired vegetative growth within the planted rice crop.

According to a sixth aspect of the invention there are provided herbicidal compositions according to the fifth aspect of the invention wherein is provided improved control and/or improved eradication of one or more of: of Sesbania hemp (Sesbania exaltata), Indian Joint vetch (Aeschynomene indica), and Alligator weed (Alternanthera philoxeroides).

According to a seventh aspect of the invention the are provided improved agricultural processes for the improved cultivation of crops of rice, especially preferably crops of rice varieties modified to be tolerant to imparted with resistance to imidazolinone type herbicides, which process comprises the application(s) of effective amounts of herbicidal compositions according to the fifth or sixth aspect of the invention.

According to an eighth aspect of the invention there are provided new regimens for the herbicidal treatment of crops of rice, especially preferably crops of rice varieties modified to be tolerant to imparted with resistance to imidazolinone type herbicides in order to provide improved undesired vegetative growth within the planted rice crop, comprising the step of applying effective amounts of herbicidal compositions according to the fifth or sixth aspect of the invention.

These and other aspects of the invention will become more apparent from the following.

Practice of certain aspects of the present invention contemplate the use of a sulfonylurea containing herbicide treatment preparation which comprises at least one sulfonylurea herbicide (viz., sulfonylurea herbicidal compound), and may optionally further include one or more further constituents. In certain and preferred aspects of the invention, the use of one or more further herbicidal treatment preparations which include at least one herbicide but which may exclude sulfonylurea herbicides are also contemplated; such are referred to as “co-herbicide treatment preparations”.

The sulfonylurea herbicides useful in the various aspects of the present invention are selected from pyrazolecarboxylic acid derivatives represented by the following formula:

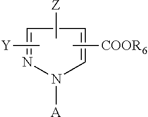

wherein Y and Z each represent a hydrogen atom, a halogen atom, a nitro group, a cyano group, COOR₁, NR₁, R₂, CONR₁R₂, SR₁, SO₂NR₁R₂, SO₂R₃, R₃CO, OR₄, CHX₂ or CX₃; A represents a hydrogen atom, an alkyl group having 1 to 4 carbon atoms, a substituted or unsubstituted phenyl group, a substituted or unsubstituted pyridyl group or OR₅; where R₁ and R₂ each represent a hydrogen atom or an alkyl group having 1 to 10 carbon atoms; R₃ represents an alkyl group having 1 to 10 carbon atoms; R₄ represents a hydrogen atom, an alkyl group having 1 to 10 carbon atoms, a substituted or unsubstituted phenyl group, CHF₂, CF₃ or CF₃CH₂; R₅ represents an alkyl group having 1 to 10 carbon atoms; and X represents a halogen atom, and R₆ is hydrogen or is a C₁-C₆ straight or branched alkyl group. These are described more fully in U.S. Pat. No. 5,053,517 to Takigawa, et al., as well as U.S. Pat. No. 5,220,025 to Iwasawa the contents of which are herein incorporated by reference.

Certain particularly preferred sulfonylurea herbicide compounds which have been observed to be useful in accordance with the present invention are halosulfuron-based herbicides, specifically a halosulfuron methyl which may be represented by the structure:

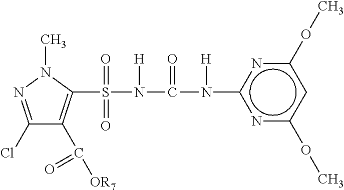

wherein R₇ is hydrogen or is a C₁-C₆ straight or branched alkyl group, preferably is hydrogen, methyl or ethyl but in a particularly preferred embodiment R₇ is methyl, and the resultant compound (in an ester form) is sometimes identified as methyl-3-chloro-5-(4,6-dimethoxypyrimidin-2-ylcarbamoylsulfamoyl)-1-methylpyrazole-4-carboxylate. The foregoing compound wherein R₇ is methyl also referred to in this specification by its brief tradename “PERMIT” (ex. Gowan Co.) which is prominent member of halosulfuron-methyl compounds having herbicidal properties. Salts or acids of the above halosulfuron-methyl compounds may also be used.

Two or more sulfonylurea herbicide compounds may be present, or a single sulfonylurea herbicide compound may be present in treatment compositions of the invention. Such sulfonylurea herbicide compounds may also be interchangeably referred to and class as ALS inhibitor herbicidal compounds.

In certain particularly preferred embodiments PERMIT is the sole sulfonylurea herbicide compound present.

In yet further particularly preferred embodiments one or more sulfonylureas are the sole herbicide(s) present in a plant treatment composition applied to a rice crop, either preemergence or post emergence.

In still further particularly preferred embodiments, PERMIT is the sole sulfonylurea herbicide compound present in a plant treatment composition applied to a rice crop, either preemergence or post emergence.

An important aspect of the present invention is the unexpected finding that the utilization the sulfonylurea herbicide compounds provides a surprising and unexpected benefit in controlling undesired vegetative growth in and amongst rice plants, such as in a rice crop, particularly wherein the rice variety is one which is imparted with traits making it resistant to imidazolinone type herbicides, especially imazethapyr type herbicides. As noted, two currently commercially available rice varieties which exhibit such tolerance are known as “Newpath” and “Clearfield” rice varieties, which are expected to be useful in conjunction with the present invention. However it is to be clearly understood that the invention is expected to find use in other rice varieties imparted with or demonstrated to exhibit tolerance of, or resistance to imidazolinone herbicides, especially imazethapyr type herbicides although not specifically named herein.

It is contemplated that the herbicidal compositions and regimens for the herbicidal treatment of crops of rice varieties taught herein may also be effective in controlling undesired vegetative growth in and amongst rice plants, such as in a rice crop, wherein the rice variety is other than one which is imparted with traits making it resistant to imidazolinone type herbicides, especially imazethapyr type herbicides.

The sulfonylurea herbicide compounds may be present in sulfonylurea based herbicide treatment preparations in any amount which is found to be herbicidally effective against unwanted vegetative growth, e.g., weeds and the like and at the same time to be not unduly detrimental to the rice crop or crop planting area onto which it is applied. Advantageously the sulfonylurea herbicide compounds, and especially preferably the particularly preferred halosulfuron-methyl compounds having herbicidal properties and most preferably the PERMIT herbicidal compound, is/are present in a sulfonylurea based herbicide treatment preparation to be applied on the rice crop in amounts corresponding to of from about 0.01 to about 32 ounces per acre, preferably from about 0.01 to about 16 ounces per acre, and especially preferably from about 0.05 to about 6 ounces per acre, and more preferably in amounts demonstrated in one or more of the following examples. It will be appreciated that the actual amount of the sulfonylurea herbicide compounds which may be required in order to achieve a desired herbicidal effect may vary from the above cited amounts as variable factors including (but not limited to): mode of application, frequency of application, the presence of or alternately the absence of other constituents which may be present, e.g. a co-herbicide, insecticide or surfactant in a sulfonylurea based herbicide treatment preparation. Other factors and variables will be recognized by a skilled artisan. Alternately the amount of the sulfonylurea herbicide compound(s) present in the sulfonylurea based herbicide treatment preparation is generally 0.0001 to 90% by weight, preferably 0.001 to 50% by weight, based on the total weight of the sulfonylurea based herbicide treatment preparation as applied to soil or onto a rice crop.

The sulfonylurea based herbicide treatment preparations may include one or more further constituents which may, for example, provide a growth regulating effect, e.g., co-herbicides, insecticides and safeners, and/or one or more further constituents which provide an ancillary benefit but which do not provide a growth regulating effect, e.g., solvents, carriers, surfactants and the like.

It is also to be understood that such one or more further constituents may be to formulate the co-herbicide treatment preparations which are useful in a treatment regimen as described herein for the control of undesired vegetative growth in and amongst rice plants, such as in a rice crop, wherein the rice variety is one which is imparted with traits making it resistant to imidazolinone type herbicides, especially Clearfield and Newpath rice varieties. One or more such co-herbicide treatment compositions may be formulated and used in a treatment regimen. It is however to be understood that all treatment regimens taught herein require at least one application of a sulfonylurea based herbicide preparation, although other applications and treatments of the rice crop with further formulations and/or preparations, e.g., co-herbicide treatment preparations which exclude a sulfonylurea based herbicide, may form part of a treatment regimen within the scope of the present invention.

The sulfonylurea based herbicide treatment preparation and/or co-herbicide treatment preparations may optionally also include one or more herbicides other than the specific sulfonylureas described previously. It is contemplated that essentially, any other chemical compounds or compounds which are known to provide a herbicidal effect may be used. By way of non-limiting example such non-sulfonylurea based herbicides include one or more of: carbamates, thiocarbamates, haloacetanilides, substituted phenoxy-, naphthoxy- and phenoxyphenoxycarboxylic acid derivatives, and heteroaryloxyphenoxyalkanecarboxylic acid derivatives such as quinolyloxy-, quinoxalyloxy-, pyridyloxy-, benzoxazolyloxy- and benzothiazolyloxyphenoxyalkanecarboxylic esters, clomazones, cyclohexanedione derivatives, imidazolinones, imazethapyrs, phosphorus-containing herbicides, for example of glufosinate type or of the glyphosate type, pyrimidinyloxypyridinecarboxylic acid derivatives, pyrimidyloxybenzoic acid derivatives, triazolopyrimidinesulfonamide derivatives and S-(N-aryl-N-alkylcarbamoylmethyl)dithiophosphoric esters. Preferred in this context are phenoxyphenoxy- and heteroaryloxyphenoxycarboxylic acid esters and salts, imidazolinones and herbicides such as bentazone, cyanazine, atrazine, dicamba or hydroxybenzonitriles such as bromoxynil and ioxynil and other foliar-acting herbicides.

Further and more specific examples of herbicides include herbicides from the following groups of compounds (sometimes also referred to by the “common names” under the reference “The Pesticide Manual” 11th Ed., British Crop Protection Council 1997, abbreviated to “PM”). By way of non-limiting examples these include one or more of:

flumioxazin (PM, pp. 576-577), for example N-(7-fluoro-3,4-dihydro-3-oxo-4-prop-2-inyl-2H-1,4-benzoxazin-6-yl)cyclohex-1-ene-1,2-dicarboxamide,

alachlor (PM, pp. 23-24), for example 2-chloro-N-(2,6-diethylphenyl)-N-(methoxymethyl)acetamide,

metolachlor (PM, pp. 833-834), for example 2-chloro-N-(2-ethyl-6-methylphenye-N-(2-methoxy-1-methylethyl)acetamide,

acetochlor (PM, pp. 10-12), for example 2-chloro-N-(ethoxymethyl)-N-(2-ethyl-6-methylphenyl)-acetamide,

dimethenamid (PM, pp. 409-410), for example 2-chloro-N-(2,4-dimethyl-3-thienyl)-N-(2-methoxy-1-methylethyl)acetamide,

pethoxamide, for example 2-chloro-N-(2-ethoxyethyl)-N-(2-methyl-1-phenyl-1-propenyl)acetamide,

atrazine (PM, pp. 55-57), for example N-ethyl-N-isopropyl-6-chloro-2,4-diamino-1,3,5-triazine,

simazine (PM, pp. 1106-1108), for example 6-chloro-N,N-diethyl-2,4-diamino-1,3,5-triazine,

cyanazine (PM, pp. 280-283), for example 2-(4-chloro-6-ethylamino-1,3,5-triazin-2-ylamino)-2-methylpropionitrile,

terbuthylazine (PM, pp. 1168-1170), for example N-ethyl-N-tert-butyl-6-chloro-2,4-diamino-1,3,5-triazine,

metribuzin (PM, pp. 840-841), for example 4-amino-6-tert-butyl-3-methylthio-1,2,4-triazin-5(4H)-one,

isoxaflutole (PM, pp. 737-739), for example (5-cyclopropyl-4-isoxazolyl)[2-(methylsulfonyl)-4-(trifluoromethyl)phenyl]methanone,

fluthiamid (=flufenacet) (PM, pp. 82-83), for example 4′-fluoro-N-isopropyl-2-(5-trifluoromethyl-1,3,4-thiadiazol-2-yloxy)acetanilide,

terbutryne (PM, pp. 1170-1172), for example N-(1,1-dimethylethyl)-N-ethyl-6-(methylthio)-1,3,5-triazine-2,4-diamine,

pendimethalin (PM, pp. 937-939), for example N-(1-ethylpropyl)-2,6-dinitro-3,4-xylidine,

sulcotrione (PM, pp. 1124-1125), for example 2-(2-chloro-4-mesylbenzoyl)cyclohexane-1,3-dione,

dicamba (PM, pp. 356-357), for example 3,6-dichloro-o-anisic acid and its salts,

mesotrione, for example 2-(4-mesyl-2-nitrobenzoyl)cyclohexane-1,3-dione,

linuron (PM, pp. 751-753), for example 3-(3,4-dichlorophenyl)-1-methoxy-1-methylurea,

benoxacor (PM, pp. 102-103), for example (.+-.)-4-dichloroacetyl-3,4-dihydro-3-methyl-2H-1,4-benzoxazine,

metosulam (PM, pp. 836-838), for example 2′,6′-dichloro-5,7-dimethoxy-3′-methyl[1,2,4]triazolo[1,5-a]pyrimidine-2-sulfonamide,

flumetsulam (PM, pp. 573-574), for example 2′,6′-difluoro-5-methyl[1,2,4]triazolo[1,5-a]pyrimidine-2-sulfonamide,

sethoxydim (PM, pp. 1101-1103), for example (.+-.)-(EZ)-(1-ethoxyiminobutyl)-5-[2-ethylthio)propyl]-3-hydroxycyclohex-2-enone,

cycloxydim (PM, pp. 290-291), for example (.+-.)-2-[1-ethoxyimino)butyl]-3-hydroxy-5-thian-3-ylcyclohex-2-enone,

clethodim (PM, pp. 250-251), for example (.+-.)-2-[(E)-1-[(E)-3-chloroallyloxyimino]propyl]-5-[2-(ethylthio)propyl]-3-hydrocyclohex-2-enone,

clefoxidim, for example 2-[1-(2-(4-chlorophenoxy)-propoxyimino)butyl]-3-oxo-5-thion-3-ylcyclohex-1-enol,

aclonifen, in particular also including its salts, such as the sodium salt, (PM, pp. 14-15), for example 2-chloro-6-nitro-3-phenoxyanilin,

MCPA (PM, pp. 770-771), for example (4-chloro-2-methylphenoxy)acetic acid, predominantly employed forms, inter alia, MCPA-butotyl, MCPA-dimethylammonium, MCPA-isoctyl, MCPA-potassium. MCPA-sodium,

2,4-D (PM, pp. 323-327), for example (2,4-dichloro-phenoxy)acetic acid, frequently employed forms: 2,4-D-butotyl, 2,4-D-butyl, 2,4-D-dimethylammonium, 2,4-D-diolamine, 2,4-D-isooctyl, 2,4-D-isopropyl, 2,4-D-trolamine,

bromoxynil (PM, pp. 149-151), for example 3,5-dibromo-4-hydroxybenzonitrile,

bentazone (PM, pp. 1064-1066), for example 3-isopropyl-2,2-dioxo-1H-2,1,3-benzothiadiazine-4(3H)-one,

fluthiacet (PM, pp. 606-608), for example [2-chloro-4-fluoro-5-[5,6,7,8-tetrahydro-3-oxo-1H,3H-1,3,4-thiadiazolo[3,4-a]pyridazine-1-ylideneamino)phenylthio]acetic acid and preferably the methyl ester,

pyridate (PM, pp. 1064-1066), for example O-6-chloro-3-phenylpyridazin-4-yl) S-octyl thiocarbonate,

diflufenzopyr (BAS 65 00 H, PM, pp. 81-82), for example 2-{1-[4-(3,5-difluorophenyl)semicarbazono]ethyl}nicotinic acid,

carfentrazone (PM, pp. 191-193), for example ethyl (RS)-2-chloro-3-[2-chloro-5-(4-difluoromethyl-4,5-dihydro-3-methyl-5-oxo-1H-1,2,4-triazol-1-yl)-4-fluorophenyl]propionate, also applied as, inter alia, carfentrazone-ethyl (as stated) or else as the acid,

clopyralid (PM, pp. 260-263), for example 3,6-dichloropyridin-2-carboxylic acid,

mecoprop, also including mecoprop-p and the esters and salts, (PM, pp. 776-779), for example (RS)-2-(4-chloro-o-tolyloxy)propionic acid,

dichlorprop, also including dichlorprop-p and the esters and salts, (PM, pp. 368-372), for example (RS)-2,4-dichlorophenoxy) propionic acid,

fluoroxypyr, (PM, pp. 597-600), for example 4-amino-3,5-dichloro-6-fluoro-2-pyridyloxyacetic acid,

profluazole, for example 1-chloro-N-[2-chloro-4-fluoro-5-[(6S,7aR)-6-fluorotetrahydro-1,3-dioxo-1H-pyrrolo[1,2-c]imidazol-2(3H)-yl]phenyl]methanesulfonamide,

amicarbazone, for example 4-amino-N-(1,1-dimethylethyl)-4,5-dihydro-3-(1-methylethyl)-5-oxo-1H-1,2,4-triazole-1-carboxamide),

trifloxysulfuron, also including its esters and salts, for example the sodium salt, for example N-[[(4,6-dimethoxy-2-pyrimidinyl)amino]carbonyl]-3-(2,2,2-trifluoroethoxy)-2-pyridinesulfonamide,

glufosinate, (PM, pp. 643-645), for example D,L-2-amino-4-[hydroxy(methyl)phosphinyl]butanoic acid and its salts and esters,

glufosinate-ammonium, (PM, pp. 643-645), for example amonium 4-[hydroxy(methyl)prosphinoyl]-DL-homoalaninate, the monoammonium salt of the acid form,

glyphosate, (PM, pp. 646-649), N-(phosphonomethyl)glycine and its salts and esters,

glyphosate-isopropylammonium, (PM, pp. 646-649), for example N-(phosphonomethyl)glycine,

imazapyr, also including its salts and esters, (PM, pp. 697-699), for example 2-(4-isopropyl-4-methyl-5-oxo-2-imidazol in-2-yl)nicotinic acid,

imazethapyr, also including its salts and esters, (PM, pp. 701-703), (RS)-5-ethyl-2-(4-isopropyl-4-methyl-5-oxo-2-imidazolin-2-yl)nicotinic acid,

imazamethabenz, also including its salts and esters, (PM, pp. 694-696), for example imazamethabenz-methyl, for example methyl (.+-.)-6-(4-isopropyl-4-methyl-5-oxo-2-imidazolin-2-yl)-m-toluate,

imazamox, also including its salts and esters, (PM, pp. 696-697), for example (RS)-2-(4-isopropyl-4-methyl-5-oxo-2-imidazolin-2-yl)-5-methoxymethylnicotinic acid,

imazaquin, also including its salts and esters, for example the ammonium salt (PM, pp. 699-701), for example (RS)-2-(4-isopropyl-4-methyl-5-oxo-2-imidazolin-2-yl)quinolin-3-carboxylic acid,

imazapic (AC 263,222), also including its salts and esters, for example the ammonium salt, (PM, pp. 5 and 6), for example (RS)-2-(4,5-dihydro-4-isopropyl-4-methyl-5-oxoimidazol-2-yl)-5-methylnicotinic acid,

clomazone, also including its salts and esters, for example, 2-[(2-chlorophenyl)methyl]-4,4-dimethyl-3-isoxazolidinone,

pyridazinone, also including its salts and esters, and

triazoles, also including its salts and esters.

When present, these one or more optional herbicides may be present in the sulfonylurea based herbicide treatment preparations and/or in the co-herbicide treatment preparation in any amount which is found to be herbicidally effective against unwanted vegetative growth, viz., weeds and the like and at the same time to be not unduly detrimental to the crop or soil onto which it is applied. Advantageously such further herbicide constituents, when present, may be present in amounts corresponding to of from about 0.01 to about 5 ounces per acre, as variable factors including as will be recognized by a skilled artisan may dictate different amounts as being suitable for application in specific applications. Alternately, when present the amount of any further optional herbicide compounds present generally in amounts of 0.0001 to 20% by weight, preferably 0.001 to 5% by weight, based on the total weight of the sulfonylurea based herbicide treatment preparation or co-herbicide treatment preparation as applied to soil or onto a plant crop.

The sulfonylurea based herbicide treatment preparation and/or co-herbicide treatment preparation may optionally also include one or more pesticides as well. Such are per-se known to the art, and include, for example, those described in The Pesticide Manual, eleventh ed., British Crop Protection Council, 1997. Preferred pesticides for the use with the system according to the present invention are e.g. selected from the group comprising Prosulfuron, Pyridate, Pyriftalid, S-Metolachlor, Simazine, Terbuthylazine, Terbutryn, Triasulfuron, Trifloxysulfuron, Trinexapac-ethyl, Ametryn, Atrazine, Benoxacor, Butafenacil, Chlortoluron, Cinosulfuron, Clodinafop, Cloquintocet, Desmetryn, Dicamba, Dimethachlor, Dimethametryn, DTPA NaFe, EDDHA NaFe, Fenclorim, Flumetralin, Fluometuron, Fluthiacetmethyl, Isoproturon, Metobromuron, Metolachlor, S-Metolachlor, Norflurazon, Oxasulfuron, Piperophos, Pretilachlor, Primisulfuron, Prometryn, Propaquizafop, Acibenzolar-S-methyl, Chlorothalonil, Cyproconazole, Cyprodinil, Difenoconazole, Fenpropidin, Fenpropimorph, Furalaxyl, Metalaxyl, Metalaxyl-M, Oxadixyl, Penconazole, Propiconazole, Pyrifenox, Thiabendazol, Abamectin, Bromopropylate, Cypermethrin, Cypermethrin High-Cis, Cyromazine, Diafenthiuron, Diazinon, Dichlorvos, Disulfoton, Emamectinbenzoate, Fenoxycarb, Formothion, Furathiocarb, Lufenuron, Methidathion, Permethrine, Codlemone, Phosphamidon, Profenofos, Pymetrozine, Quinalphos, Thiamethoxam, Thiocyclam, Thiometon and Trifloxystrobin. While pesticides may be omitted, when present they may be included in any effective amounts. Representative amounts are from about 0.01% to about 10% by weight, preferably from about 0.05 to about 5% by weight, based on the total weight of the sulfonylurea based herbicide treatment preparation and/or co-herbicide treatment preparation of which the pesticide forms a part.

The sulfonylurea based herbicide treatment preparations and/or co-herbicide treatment preparation may include still further optional constituents which will be recognized as being commonly encountered as useful in herbicidal compositions, particularly largely aqueous herbicidal compositions which are adapted to be applied by conventional spraying methods and machinery. Such include by way of example: surfactants, safeners, oils, conventional adhesives, wetters, dispersants, emulsifiers, preservatives, antifreeze agents, solvents, oils, fillers, colorants, carriers, antifoams, evaporation inhibitors, pH regulators or viscosity regulators. Such are not usually considered to be constituents which have a growth regulating benefit or effect.

One such optional constituent are one or more surfactants. Exemplary useful surfactants include those which may be of the ionic and nonionic type, such as aromatic-based surfactants, e.g., surface-active benzenes or phenols which are substituted by one or more alkyl groups and have subsequently been derivatized, or nonaromatic-based surfactants, for example heterocycle-, olefin-, aliphatic- or cycloaliphatic-based surfactants, for example surface-active pyridine, pyrimidine, triazine, pyrrole, pyrrolidine, furan, thiophene, benzoxazole, benzothiazole and triazole compounds which are substituted by one or more alkyl groups and have subsequently been derivatized.

Examples of aromatic surfactants include phenols, phenyl (C₁-C₄)alkyl ethers or (poly)alkoxylated phenols for example those having 1 to 50 alkyleneoxy units in the (poly)alkyleneoxy moiety, where the alkylene moiety has preferably in each case 1 to 4 carbon atoms, preferably phenol which has been reacted with 3 to 10 mol of alkylene oxide, (poly)alkylphenols or (poly)alkylphenol alkoxylates for example those having 1 to 12 carbon atoms per alkyl radical and 1 to 150 alkyleneoxy units in the polyalkyleneoxy moiety, preferably triisobutylphenol or tri-n-butylphenol which has been reacted with 1 to 50 mol of ethylene oxide, polyarylphenols or polyarylphenol alkoxylates, for example tristyrylphenol polyalkylene glycol ethers with 1 to 150 alkyleneoxy units in the polyalkyleneoxy moiety, preferably tristyrylphenol which has been reacted with 1 to 50 mol of ethylene oxide, compounds which formally constitute the reaction products of the foregoing molecules with sulfuric acid or phosphoric acid and their salts which have been neutralized with suitable bases, for example the acid phosphoric ester of the triethoxylated phenol, the acid phosphoric ester of a nonylphenol which has been reacted with 9 mol of ethylene oxide, and the triethanolamine-neutralized phosphoric acid ester of the reaction product of 20 mol of ethylene oxide and 1 mol of tristyrylphenol, and, acid (poly)alkyl- and (poly)arylbenzenesulfonates which have been neutralized with suitable bases, for example having 1 to 12 carbon atoms per alkyl radical, or having up to 3 styrene units in the polyaryl radical, preferably (linear) dodecylbenzenesulfonic acid and its oil-soluble salts such as, for example, the isopropylammonium salt of dodecylbenzenesulfonic acid.

Examples of nonaromatic surfactants are described hereinafter wherein it is to be understood that “EO” represents ethylene oxide units, “PO” represents propylene oxide units and “BO” represents butylene oxide units. Usually, in the case of the alkyleneoxy units, ethyleneoxy, propyleneoxy and butyleneoxy units, in particular ethyleneoxy units, are preferred.

Exemplary nonaromatic surfactants include fatty alcohols having 10-24 carbon atoms with 0-60 EO and/or 0-20 PO and/or 0-15 BO in any desired sequence. The terminal hydroxyl groups of these compounds can be terminally capped by an alkyl, cycloalkyl or acyl radical having 1-24 carbon atoms. Examples of such compounds are commercially available in the Genapol® C,L,O,T,UD,UDD,X (ex. Clariant), Plurafac® and Lutensol® A,AT,ON,TO (ex. BASF), Marlipal®24 and O13 (ex. Condea), Dehypon® (ex. Henkel), series of surfactants, as well as anionic derivatives of the immediately foregoing described nonaromatic surfactants in the form of ether carboxylates, sulfonates, sulfates and phosphates and their inorganic salts (for example alkali metal salts and alkaline earth metal salts) and/or their organic salts (for example on an amine or alkanolamine base) such as are presently commercially available as Genapol® LRO, Sandopan®, and Hostaphat/Hordaphos® series of surfactants (ex. Clariant.) Further exemplary useful nonaromatic surfactants include copolymers composed of EO,PO and/or BO units such as, for example, block copolymers such as those currently commercially available as Pluronic® (ex. BASF) having a molecular weight of 400 to 10⁸. Further useful nonaromatic surfactants include alkylene oxide adducts of C₁-C₉alcohols such as Atlox® 5000 (ex. Uniquema).

Further useful nonaromatic surfactants include anionic derivatives of certain of the foregoing nonaromatic surfactants in the form of ether carboxylates, sulfonates, sulfates and phosphates and their inorganic salts (for example alkali metal salts and alkaline earth metal salts) and organic salts (for example on an amine or alkanolamine base). Still further useful nonaromatic surfactants include fatty acid and triglyceride alkoxylates, salts of aliphatic, cycloaliphatic and olefinic carboxylic acids and polycarboxylic acids, and alpha-sulfofatty acid esters, fatty acid amide alkoxylates, alkylene oxide adducts of alkyne diols such as are presently commercially available as Surfynol® (ex. Air Products).

Yet further useful nonaromatic surfactants which may be used include sugar derivatives such as amino and amido sugars, glucitols, alkyl polyglycosides such are presently commercially available as APG® (ex. Henkel), sorbitan esters such as are available as Span® or Tween® surfactants (ex. Uniquema), cyclodextrin esters or ethers from (ex. Wacker), surface-active cellulose and algin, pectin and guar derivatives, and guar derivatives.

Still further useful nonaromatic surfactants include alkylene oxide adducts on a polyol base, surface-active polyglyceridesm sulfosuccinates, alkanesulfonates, paraffin- and olefinsulfonates, alkylene oxide adducts of fatty amines, surface-active, zwitterionic compounds including as taurides, betaines and sulfobetaines, perfluorinated as well as polyfluorinated surface-active compounds such as are presently commercially available as Fluowet®. (ex. Clariant), or Bayowet® (ex. Bayer), or Zonyl® (ex. DuPont) series of products.

Yet further useful as nonaromatic surfactants are surface-active polyacrylic and methacrylic derivatives such as the Sokalan® (ex. BASF) materials, surface-active polyamides such as modified gelatin or derivatized polyaspartic acid (e.g., ex. Bayer) and their derivatives, surface-active polymers based on maleic anhydride and/or reaction products of maleic anhydride, and copolymers comprising maleic anhydride and/or reaction products of maleic anhydride, surface-active derivatives of montan, polyethylene and polypropylene waxes, surface-active phosphonates and phosphinates such as are presently commercially available as Fluowet®-PL (ex. Clariant) and, poly- or perhalogenated surfactants such as, for example, Emulsogen®-1557 (ex. Clariant).

Further surfactants include silicone based surfactants, viz, those which include at least one silicone atom. Such are per se, known to the art.

When present the one or more surfactants which may be present will be included in the sulfonylurea based herbicide treatment preparations and/or co-herbicide treatment preparation in effective amounts. In general, the total concentration of any surfactants present is advantageously from about 0.001 to about 50% by weight, preferably 0.1 to 40% by weight, in particular 0.1 to 30% by weight, based on the total weight of the sulfonylurea based herbicide treatment preparation and/or co-herbicide treatment preparation of which it forms a part.

One or more safeners may be included in the sulfonylurea based herbicide treatment preparations and/or co-herbicide treatment preparation in effective amounts. Various classes of chemical compounds are known to the art as effective safeners, non-limiting examples of which include: Benoxacor, Cloquintocet, cyometrinil, cyprosulfamide, dichlormid, dicyclonon, dietholate, fenchlorazole-ethyl, fenclorim, flurazole, fluxofenim, furilazole, isoxadifen-ethyl, mefenpyr-diethyl, mephenate, MG-191, napthalic anhydride, and Oxabetrinil.

When present the one or more safeners which may be present will be included in the sulfonylurea based herbicide treatment preparations and/or co-herbicide treatment preparation in effective amounts. In general, the total concentration of any safeners present is advantageously from about 0.001 to about 5% by weight, preferably 0.1 to 4% by weight, in particular 0.1 to 3% by weight, based on the total weight of the specific herbicide treatment preparation of which it forms a part.

The foregoing safeners may beneficially reduce or prevent phytotoxic effects which may be observed when a sulfonylurea based herbicide treatment preparation and/or co-herbicide treatment preparation according to the invention is employed in crops of useful plants, without adversely affecting the efficacy of the herbicides against harmful plants. This makes it possible considerably to widen the spectrum of application of the sulfonylurea based herbicide treatment preparation and/or co-herbicide treatment preparation according to the invention; in particular, the use of safeners makes possible the application of sulfonylurea based herbicide treatment preparation and/or co-herbicide treatment preparation which could previously only be employed to a limited extent or with insufficient success, i.e. of combinations which, at low dosages with a poor spectrum of action, led to insufficient control of the harmful plants without safener. Depending on their properties, when present and/or when used, one or more of the foregoing safeners can be used for pretreating the seed of the crop plant (seed dressing) or introduced to the crop area, e.g. rice paddy or field prior to sowing or applied together before or after emergence of the plants. Pre-emergence treatment includes both the treatment of the area under cultivation before sowing and the treatment of the areas under cultivation where seed has been sown, but growth is as yet not present.

The application rates of the safeners, can vary within wide limits, but in general, the total concentration of any safener present is advantageously from about 0.001 to about 8% by weight, preferably 0.1 to 4.0% by weight, in particular 0.1 to 0.5% by weight, based on the total weight of the sulfonylurea based herbicide treatment preparation and/or co-herbicide treatment preparation of which the safener forms a part.

The sulfonylurea based herbicide treatment preparations and/or co-herbicide treatment preparation may include one or more oils in effective amounts.

Often, herbicidal activity of a herbicidal compound can also be increased by using vegetable oils. The term vegetable oils is to be understood as meaning oils from oil-plant species, such as soya oil, rapeseed oil, corn oil, sunflower oil, cottonseed oil, linseed oil, coconut oil, palm oil, safflower oil or castor oil, in particular soybean oil, castor oil, rapeseed oil, and their transesterification products, for example alkyl esters, such as rapeseed oil methyl ester or rapeseed oil ethyl ester.

The vegetable oils are preferably esters of C₁₀-C₂₂-, preferably C₁₂-C₂₀-fatty acids. The C₁₀-C₂₂-fatty acid esters are, for example, esters of unsaturated or saturated C₁₀-C₂₂-fatty acids, in particular those with an even number of carbon atoms, for example erucic acid, lauric acid, palmitic acid and, in particular, C₁₈-fatty acids such as stearic acid, oleic acid, linoleic acid or linolenic acid. Specific examples of C₁₀-C₂₂-fatty acid esters are esters obtained by reacting glycerol or glycol with the C₁₀-C₂₂-fatty acids as they exist, for example, in oils from oil-plant species, or C₁-C₂₀-alkyl-C₁₀-C₂₂-fatty acid esters as can be obtained, for example, by transesterification of the above-mentioned glycerol- or glycol-C₁₀-C₂₂-fatty acid esters with C₁-C₂₀-alcohols (for example methanol, ethanol, propanol or butanol). Preferred C₁-C₂₀-alkyl-C₁₀-C₂₂-fatty acid esters are the methyl, ethyl, propyl, butyl, 2-ethylhexyl and dodecyl esters. Preferred glycol- and glycerol-C₁₀-C₂₂-fatty acid esters are the uniform or mixed glycol esters and glycerol esters of C₁₀-C₂₂-fatty acids, in particular of those fatty acids which have an even number of carbon atoms, for example erucic acid, lauric acid, palmitic acid and, in particular, C₁₈-fatty acids such as stearic acid, oleic acid, linolic acid or linolenic acid.

The application rates for one or more oils, when present as part of sulfonylurea based herbicide treatment preparations, and/or co-herbicide treatment preparation may vary widely but in general are advantageously from about 0.001% to about 5% by weight, preferably from about 0.5% to about 1% by weight, based on the total weight of the sulfonylurea based herbicide treatment preparation and/or co-herbicide treatment preparation of which one or more such oils form a part. In certain preferred embodiments, especially where co-herbicides are absent, vegetable oils are also absent from the sulfonylurea based herbicide treatment preparations as they may deleteriously affect the stability of the sulfonylurea based herbicidal compound(s) present.

The sulfonylurea based herbicide treatment preparations and/or co-herbicide treatment preparation may include one or more non-aqueous solvents in effective amounts. Representative solvents include: aromatic hydrocarbons, preferably the fractions containing 8 to 12 carbon atoms such as mixtures of alkylbenzenes, typically xylene mixtures or alkylated naphthalenes; aliphatic and cycloaliphatic hydrocarbons such as paraffins, cyclohexane or tetrahydronaphthalene; alcohols such as ethanol, propanol or butanol; glycols and their ethers and esters such as propylene glycol or dipropylene glycol ether; ketones such as cyclohexanone, isophorone or diacetone alcohol; strongly polar solvents such as N-methyl-2-pyrrolidone, dimethyl sulfoxide, and in some cases also silicone oils. While such non-aqueous solvents may be omitted, when present they may be included in any effective amounts. Representative amounts are from about 0.01% to about 90% by weight, preferably from about 0.1 to about 75% by weight, based on the total weight of the sulfonylurea based herbicide treatment preparation and/or co-herbicide treatment preparation within which the non-aqueous solvent is present, or of which the non-aqueous solvent forms a part.

The sulfonylurea based herbicide treatment preparations and/or co-herbicide treatment preparation may include solid carriers in effective amounts. Non-limiting examples of suitable carriers include materials known to the relevant art and are solid carriers typically used for dusts and dispersible powders are usually natural mineral fillers such as calcite, talcum, kaolin, montmorillonite or attapulgite. To improve the physical properties it is also possible to add highly dispersed silicic acid or highly dispersed absorbent polymers. Suitable granulated adsorptive carriers are porous types, including pumice, broken brick, sepiolite or bentonite; and suitable nonsorbent carriers are materials such as calcite or sand. In addition, innumerable pregranulated materials of inorganic or organic origin may be used, especially dolomite or pulverised plant residues. When present, such solid carriers may be included in any effective amounts. Representative amounts are from about 0.001% to about 25% by weight, preferably from about 15% to about 25% by weight, based on the total weight of the sulfonylurea based herbicide treatment preparation and/or co-herbicide treatment preparation within which the solid carriers is present, or of which the solid carriers forms a part.

In certain preferred embodiments, especially where co-herbicides are absent, solid carriers are also absent from the sulfonylurea based herbicide treatment preparations as they may deleteriously affect the stability of the sulfonylurea based herbicidal compound(s) present.

In certain products formats of the sulfonylurea based herbicide treatment preparation and/or co-herbicide treatment preparation, a major amount of water may be added to the other constituents present in the respective treatment preparation in order to form a tank mix or working solution or dispersion of the said forgoing constituents which in such a form is particularly adapted to be delivered by spraying. Water may be used as a carrier or a solvent for one or more of the constituents present in the sulfonylurea based herbicide treatment preparation and/or co-herbicide treatment preparation, or water may be both a solvent and carrier.

The sulfonylurea based herbicide treatment preparations can exist only as at least one sulfonylurea herbicide which may be provided without any further constituents. As noted previously the co-herbicide treatment preparation differs only from the sulfonylurea based herbicide treatment preparation in that it excludes one or more sulfonylurea based herbicidal compounds disclosed previously, especially halosulfuron methyl, e.g., PERMIT.

The sulfonylurea based herbicide treatment preparation and/or co-herbicide treatment preparation may be applied in a customary manner as a dilution with water, but also as so-called tank mixes by jointly diluting the separately formulated, or partially separately formulated, components with water and/or other liquid carrier or solvents in order to form the sulfonylurea based herbicide treatment preparation and/or co-herbicide treatment preparation.

The sulfonylurea based herbicide treatment preparations and/or co-herbicide treatment preparation can be formulated in various ways, depending on the prevailing biological and/or chemical-physical parameters. The following are examples of general possibilities for formulations: wettable powders (WP), water-soluble concentrates, emulsifiable concentrates (EC), aqueous solutions (SL), emulsions (EW) such as oil-in-water and water-in-oil emulsions, sprayable solutions or emulsions, suspension concentrates (SC), oil- or water-based dispersions, suspoemulsions, dusts (DP), seed-dressing materials, granules for soil application or for broadcasting, or water-dispersible granules (WG), ULV formulations, microcapsules or waxes.

Advantageously, the sulfonylurea based herbicide treatment preparations may be combinations with further constituents, e.g., other pesticidally active substances, such as other herbicides, fungicides or insecticides, and with safeners, fertilizers and/or growth regulators, may also be prepared, for example in the form of a readymix or a tank mix. Similarly, the co-herbicide treatment preparation may be combinations of several constituents, e.g., other pesticidally active substances, herbicides other than sulfonylurea based herbicidal compounds, fungicides or insecticides, and with safeners, fertilizers and/or growth regulators, may also be prepared, for example in the form of a readymix or a tank mix.

The sulfonylurea based herbicide treatment preparations and/or co-herbicidal treatment preparations may, in addition to dilutable concentrates, may also be provided and/or used in other product forms.

Wettable powders (sprayable powders) are product forms which are uniformly dispersible in water and which, in addition to any herbicidal compound, e.g., sulfonylurea based herbicidal compounds or other non-sulfonylurea based herbicidal compounds and any other optional constituents, frequently also comprise ionic or nonionic surfactants (wetters, dispersants), for example polyoxethylated alkylphenols, polyethoxylated fatty alcohols or fatty amines, alkanesulfonates or alkylbenzenesulfonates, sodium lignosulfonate, sodium 2,2′-dinaphthylmethane-6,6′-disulfonate, sodium dibutylnaphthalenesulfonate or else sodium oleoylmethyltauride, in addition to a diluent or inert material.

In certain preferred embodiments, especially where co-herbicides are absent, the sulfonylurea based herbicide treatment preparations are provided in the form of wettable powders.

Emulsifiable concentrates are another product form which may be prepared by dissolving the sulfonylurea based herbicide or other herbicidal compound in a suitable organic solvent, for example butanol, cyclohexanone, dimethylformamide, xylene or else higher-boiling aromatics or hydrocarbons, usually with addition of one or more ionic or nonionic surfactants (emulsifiers). Examples of emulsifiers which may be used are: calcium salts of alkylarylsulfonic acids, such as calcium dodecylbenzene sulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxethylene sorbitol esters.

Typically, dusts are a further product form which is obtained by grinding the sulfonylurea based herbicide or other herbicidal compound with finely divided solid materials, for example talc, natural clays such as kaolin, bentonite and pyrophyllite, or diatomaceous earth.

Still further product forms are suspension concentrates (SC) which can be water- or oil-based. They can be prepared, for example, by wet grinding by means of commercially available bead mills and, if appropriate, addition of further surfactants as they have already been mentioned for example above in the case of the other formulation types.

Emulsions, for example oil-in-water emulsions (EW), are yet another product form which can be prepared for example by means of stirrers, colloid mills and/or static mixers using aqueous organic solvents and, if appropriate, further surfactants as have already been mentioned for example above in the case of the other formulation types.

A still further product form are granules. Granules can be prepared either by spraying the sulfonylurea based herbicide and any further optional constituents (where appropriate) onto an adsorptive, granulated inert material or by applying sulfonylurea based herbicide and any further optional constituents (where appropriate) to the surface of carriers such as sand, kaolites or granulated inert material with the aid of binders, for example polyvinyl alcohol, sodium polyacrylate or else mineral oils. Granulation may occur in the manner conventionally used for the production of fertilizer granules, if desired in a mixture with fertilizers. As a rule, water-dispersible granules are prepared by conventional processes such as spray drying, fluidized-bed granulation, disk granulation, mixing with high-speed mixers and extrusion without solid inert material, according to techniques known to the art.

Advantageously, the sulfonylurea based herbicide treatment preparations comprise 0.01 to 99.9% wt. in particular 0.1 to 95% by weight, of sulfonylurea based herbicide compound, the following concentrations being customary, depending on the type of formulation: The concentration of the sulfonylurea based herbicide compound in wettable powders is, for example, approximately 10 to 95% by weight, the remainder to 100% by weight being composed of customary formulation constituents. In the case of emulsifiable concentrates, the concentration of sulfonylurea based herbicide compound may amount to, for example, 1 to 80% by weight. Sulfonylurea based herbicide treatment preparations in the form of dusts comprise, in most cases, 1 to 30% by weight of sulfonylurea based herbicide compound, while preparations in the form of sprayable solutions typically comprise approximately 0.01 to 25% by weight of sulfonylurea based herbicide.

The former product forms, are similarly applicable for co-herbicide treatment preparations.

Preferred formulations include the following representative compositions:

Emulsifiable concentrates:

sulfonylurea based herbicide: 1 to 90% wt., preferably 5 to 20% wt.

surfactant(s): 1 to 30% wt., preferably 10 to 20% wt.

liquid carrier: 5 to 94% wt., preferably 70 to 85% wt.

optional constituents: 0 to 35% wt.

### Dusts:

sulfonylurea based herbicide: 0.1 to 10% wt., preferably 0.1 to 5% wt.

solid carrier 99.9 to 90% wt., preferably 99.9 to 99% wt.

optional constituents: 0 to 35% wt.

### Suspension Concentrates:

sulfonylurea based herbicide: 5 to 75% wt., preferably 10 to 50% wt.

oil and/or water: 94 to 24% wt., preferably 88 to 30% wt.

surfactant(s): 1 to 40% wt., preferably 2 to 30% wt.

optional constituents; 0 to 35% wt.

### Wettable Powders:

sulfonylurea based herbicide: 0.5 to 90% wt., preferably 1 to 80% wt.

surface-active agent: 0.5 to 20% wt., preferably 1 to 15% wt.

solid carrier: 5 to 95% wt., preferably 15 to 90% wt.

optional constituents: 0 to 35% wt.

### Granules:

sulfonylurea based herbicide: 0.1 to 30% wt., preferably 0.1 to 15% wt.

solid carrier: 99.5 to 70% wt., preferably 97 to 85% wt.

optional constituents: 0 to 35% wt.

Particularly preferred product forms of the sulfonylurea based herbicide treatment preparations are water dispersible granules as well as wettable powders as they are effectively applied. Further, such product forms offer good product stability, relatively easy handling and when necessary measuring, and ready dispersability into a liquid carrier, e.g., water. For use, the sulfonylurea based herbicide treatment preparations, and where applicable the co-herbicide treatment preparation, are optionally diluted in the customary manner, for example using water in the case of wettable powders, emulsifiable concentrates, dispersions and water-dispersible granules. Sulfonylurea based herbicide treatment preparations and where applicable the co-herbicide treatment preparation, in the form of dusts, soil granules, granules for broadcasting and sprayable solutions are usually not diluted further with other inert substances prior to use.

The sulfonylurea based herbicide treatment preparations and where applicable the co-herbicide treatment preparation, can be applied to the plants, parts of the plants, seeds of the plants or the area under cultivation (soil of a field), preferably to the green plants and parts of the plants and, if appropriate, additionally to the soil of the field. One possible use is the joint application of the active ingredients in the form of tank mixes, the concentrated formulations of the individual active ingredients, in optimal formulations, jointly being mixed with water in the tank and the resulting spray mixture being applied.

Sprayable forms of sulfonylurea based herbicide treatment preparations and where applicable the co-herbicide treatment preparation, can be prepared from a liquid concentrate by diluting said concentrate containing at least the sulfonylurea based herbicide in an appropriate volume of water and agitating as needed. The resulting sprayable composition can then be applied, for example by spraying, to any unwanted vegetation to be killed or controlled. Sprayable forms of sulfonylurea based herbicide treatment preparations and where applicable the co-herbicide treatment preparation, can be prepared from particulate solids by dissolving or dispersing the particulate solids in an appropriate volume of water, agitating as needed, and applying to unwanted vegetation.

Once prepared, such should be used within 2 to 48 hours following preparation, depending upon various conditions. Alternately, sprayable forms of the sulfonylurea based herbicide treatment preparations and where applicable the co-herbicide treatment preparation can also be foimed by dissolving or dispersing the sulfonyl urea based herbicide treatment preparation into a liquid carrier, e.g., water, or an aqueous/organic solvent mixture.

Advantageously, such sprayable forms of sulfonylurea based herbicide treatment preparations and where applicable the co-herbicide treatment preparation, are applied as aqueous solutions or dispersions, whether they result from the further dilution of the liquid concentrate or the addition of water to the particulate solid concentrate. The term “aqueous” as used herein is not intended to exclude the presence of some small amount of nonaqueous solvent, so long as the predominant solvent present, other than the glycol or glycol ester component of the surfactant composition, is water. Said sprayable compositions included in the present invention can be applied to the foliage of the plants to be treated through any of the appropriate methods that are well known to those having skill in the art.

The sulfonylurea based herbicide treatment preparations provide surprising herbicidal effectiveness which is one of the biological effects that can be enhanced through this invention. “Herbicidal effectiveness,” as used herein, refers to any observable measure of control of plant growth, which can include one or more of the actions of (1) killing, (2) inhibiting growth, reproduction or proliferation, and (3) removing, destroying, or otherwise diminishing the occurrence and activity of plants. The herbicidal effectiveness data set forth herein report “control” as a percentage following a standard procedure in the art which reflects a visual assessment of plant mortality and growth reduction by comparison with untreated plants, made by technicians specially trained to make and record such observations.

The selection of application rates that are biologically effective for the sulfonylurea based herbicide treatment preparations taught herein is within the skill of the ordinary agricultural scientist. Those of skill in the art will likewise recognize that individual plant conditions, weather and growing conditions, as well as the specific sulfonylurea based herbicide treatment preparation selected for use, will affect the efficacy achieved in practicing this invention. Useful application rates for sulfonylurea based herbicide treatment preparations can depend upon all of the above conditions. In general, the sulfonylurea based herbicide treatment preparations of the present invention is applied to plants at a rate sufficient to give the desired biological effects: control of undesired vegetative growth, and preferably improved herbicidal effectiveness against one or more of Sesbania hemp (Sesbania exaltata), Indian Joint vetch (Aeschynomene indica), and Alligator weed (Alternanthera philoxeroides). The amount of the sulfonylurea based herbicide treatment preparations applied to rice plants in combination generally provides a herbicidally-effective amount of at least the sulfonylurea based herbicide. These application rates are usually expressed as amount of sulfonylurea based herbicide per unit area treated, e.g. grams per hectare (g/ha) or ounces per acre (oz/a). What constitutes a “desired effect” varies according to the standards and practice of those who investigate, develop, market and use herbicidal compositions and/or other plant treatment compositions. Typically, the amount of an effective herbicidal composition, e.g., the sulfonylurea based herbicide treatment preparation, applied per unit area is to give at least 85% control of a an undesired plant species, viz., undesired vegetative growth, as measured by growth reduction or mortality which is often used to define a commercially effective rate for the herbicidal composition. Early visual symptoms of treatment generally should appear no later than seven days after treatment, preferably no later than four days after treatment, but preferably sooner.

In one or more further aspects, the present invention also provides improved agricultural processes for the improved cultivation of crops of rice varieties modified to be tolerant to imparted with resistance to imazethapyr type herbicides wherein the crops are treated to control undesired vegetative growth using a halosulfuron-methyl herbicidal composition to provide improved herbicidal efficacy.

Examples of such undesired vegetative growth which may be found in rice crops include: Spiny Amaranth (Amaranth spinosus) Barnyard Grass (Echinochloa crusgalli), Bindweed (Calystegia sepium), Burcucumber (Sicyas angulatus), California Arrowhead (Sagittaria montevidensis) Common Cocklebur (Xanthium strumarium), Corn Spurry (Spergula arvensis), Wooly Cupgrass (Eriochloa villosa), Dayflower (Commelina erecta), Dogbane Hemp, (Apocynum cannabinum), Eclipta (Ecilpta prostrata), Rice Flatsedge (Cyperus iria), Philadelphia Fleabane (Erigeron philadelphicus), Foxtail, (Galinsoga) Golden Crownbeard (Verbesina encliodes), Goosefoot Groundsel (Senecio vulgaris), Horsenettle, (Solanum carolinense), Horseweed/Marestail (Erigeron Canadensis), Horsetail (Equisetum), Jimsonweed (Datura stramonium), Itchgrass (Rottboellia cochinchinensis), Jointvetch (Aeschynomene), Johnsongrass rhizome, seedling (Sorghum halepense), Kochia (Kochia scoparia), Ladysthumb (Polygonum persicaria), Lambsquarter, common (Chenoposium album), Mallow, Venice (Hibiscus trionum), Milkweed, common (Asclepias syriaca), Milkweed, honeyvine (Ampelamus albidus), Millet, Wild Proso (Paniucum miliaceum), Morningglory, Ivyleaf (Ipomoea hederacea), Tall Morningglory (Ipomoea purppurea), Wild Mustard (Sinapis arevensis), Black Nightshade (Solanum americanum), Yellow Nutsedge (Cyperus exculentus), Purple Nutsedge (Cyperus rotundus), Oats, Fall Panicum (Paniucm dichotomiflorum), Texas Panicum (Panicum texanum), Maypop Passionflower (Passiflora incarnate), Redroot Pigweed (marunthus retroffiexus), Smooth Pigweed (Amaranthus hybridus), Pokeweed, common (Phytolacca Americana), Purslane (Portulaca oleracea), Quackgrass (Elytrigia repense), wild Radish (Rapharius raphanistrum), Ragweed, common (Ambrosia artemisiifolia), Ragweed (Ambrosia trifida), Redstem (Ammania auriculata), Ricefield Bulrush (Scirpus mucronatus), Italian Ryegrass (Lollum multiflorum), Sandbur, Sesbania, Hemp (Sesbania exaltata), Shattercane (Sorghum bilcolor) Signalgrass, broadleaf, Shepherdspurse (capsella bursa pastoris(L.) medicus), Prickly Sida, Smallflower Umbrellaplant, Pennsylvania Smartweed (Polyfonum pensylvanisum), Sorghum Almum, Canada Thistle (Cirsium arvense), Sunflower (Helianthus annuus) and Velvetleaf (Abutilan theophrasti).

The application of the sulfonylurea based herbicide treatment preparations have been observed to be surprisingly effective against Sesbania Hemp (Sesbania exaltata), Indian Joint vetch (Aeschynomene indica), and Alligator Weed (Alternanthera philoxeroides). Such as been observed when sulfonylurea based herbicide treatment preparations have been are applied to a rice crop of a rice variety is modified to be tolerant to imazethapyr.

Thus, in a further aspect of the invention there are provided new regimens for the herbicidal treatment of crops of rice varieties modified to be tolerant to imparted with resistance to imidazolinone type herbicides in order to provide improved undesired vegetative growth within the planted rice crop. Such new regimens require one or more applications of a sulfonylurea based herbicide treatment preparations to rice crop of a rice variety is modified to be tolerant to imazethapyr, especially Newpath and/or Clearfield rice varieties, which may regimen may optionally include the application or applications of one or more further co-herbicidal treatment preparations to the rice crop. Preferably the new treatment regimens provide a greatly improved, more preferably a synergistic degree of control of one or more pernicious vegetative growths which are troublesome to eradicate utilizing normal herbicidal treatment regimens, especially one or more of Sesbania hemp (Sesbania exaltata), Indian Joint vetch, and Alligator weed, as compared to a like regimen which however omits the application or applications of sulfonylurea based herbicide treatment preparations to rice crop.

The rate of application of the sulfonylurea based herbicide treatment preparations may vary within wide limits and depends on the nature of the soil, the type of use (pre- or post-emergence; seed dressing; application to the seed furrow; no tillage application etc.), the crop plant, the weed to be controlled, the prevailing climatic conditions, and other factors determined by the type of use, time of use and target crop. Generally, the sulfonylurea based herbicide treatment preparations according to the invention can be applied at a rate of application of from 0.1 to 5000 grams of the sulfonylurea based herbicide present in a treatment preparation per hectare.

The following examples below illustrate exemplary formulations as well as preferred embodiments of the invention. It is to be understood that these examples are provided by way of illustration only and that further useful formulations falling within the scope of the present invention and the claims may be readily produced by one skilled in the art without deviating from the scope and spirit of the invention.

### EXAMPLES

### Example I

A number of separate test areas were used to evaluate the efficacy of certain treatment regimens for the control of undesired vegetative growth in a rice crop planted with Newpath variety rice. The identity of the constituents and timings of application of two regimens which excluded the use of sulfonylurea based herbicide treatment preparations, and six regimens which included the application of at least one sulfonylurea based herbicide treatment preparation is described on the following Table 1.

TABLE 1

| | | % control of undesired vegetative growth/ | | |
|---|---|---|---|---|
| | | [% improvement compared to C2] | | |
| | | Sesbania | Indian Joint | |
| | Treatment Regimen | hemp | vetch | Alligator weed |
| C1 | single application of CMD (0.3 lb/acre) | 0% | 0% | 0% |
| C2 | single application of CMD (0.3 lb/acre) applied Pre; | 15% | 15% | 66% |
| | subsequently, single application of NP (4 oz/acre) applied VE Post; | | | |
| | subsequently, single application of NP (4 oz/acre) applied M Post | | | |
| E1 | single application of CMD (0.3 lb/acre) applied Pre; | 90% | 90% | 75% |
| | subsequently, single application of NP (4 oz/acre) applied VE Post; | [+500%] | [+487%] | [+13.6%] |
| | subsequently, combined application of NP (4 oz/acre) with P (0.5 oz/acre) | | | |
| | simultaneously applied M Post | | | |
| E2 | single application of CMD (0.3 lb/acre) applied Pre; | 84% | 79% | 56% |
| | subsequently, combined application of NP (4 oz/acre) with P (0.5 oz/acre) | [+460%] | [+427%] | [+10.6%] |
| | simultaneously applied M Post | | | |
| E3 | single combined application of CMD (0.3 lb/acre) with NP (4 oz/acre) | 90% | 90% | 76% |
| | applied VE Post | [+500%] | [+500%] | [+15.2] |
| | subsequently, single combined application of NP (4 oz/acre) with P | | | |
| | (0.67 oz/acre) applied M Post; | | | |
| E4 | single application of CMD (0.3 lb/acre) applied Pre; | 83% | 80% | 79% |
| | subsequently, single combined application of NP (4 oz/acre) with P | [+453%] | [+433%] | [+19.7%] |
| | (0.67 oz/acre) applied VE Post; | | | |
| | subsequently, single application of NP (4 oz/acre) applied M Post | | | |
| E5 | single application of CMD (0.3 lb/acre) applied Pre; | 93% | 93% | 81% |
| | subsequently, single application of NP (4 oz/acre) applied VE Post; | [+520%] | [+520%] | [+22.7%] |
| | subsequently, single combined application of NP (4 oz/acre) with P | | | |
| | (1.0 oz/acre) applied M Post; | | | |
| E6 | single application of CMD (0.3 lb/acre) applied Pre; | 90% | 88% | 79% |
| | subsequently, single combined application of NP (4 oz/acre) with P | [+500%] | [+487%] | [19.7%] |
| | (1.0 oz/acre) applied VE Post; | | | |
| | subsequently, single application of NP (4 oz/acre) applied M Post | | | |
| | Average improvement over C1, C2 | 488.8% | 475.7% | 16.9% |

In the foregoing Table 1 (as well as following Table 2):
“CMD” indicates the application of COMMAND herbicide (an isoxazolidinone based herbicide, ex. FMC) which was applied to the rice crop at the effective concentration of the indicated lbs/acre,
“NP” indicates the application of NEWPATH herbicide (an imidazolinone based herbicide, ex. BASF AG) which was applied to the rice crop at the effective concentration of the indicated oz./acre,
“P” indicates the application of PERMIT herbicide, viz., halosulfuron methyl, which was applied to the rice crop at the effective concentration of the indicated oz./acre,
“Pre” indicates that the application was pre-emergence,
“Post” indicates that the application was post-emergence,
“VE” indicated that that application was at an early stage in the growth of the rice plants, generally at the manifestation of 1-3 leaves/blades per rice plant,
“ME” indicated that that application was at a subsequent stage in the growth of the rice plants, generally at the manifestation of 4-5 leaves/blades per rice plant,
“M” indicated that that application was at a subsequent stage in the growth of the rice plants, generally at the manifestation of 5-7 leaves/blades per rice plant.

Application of the above treatment compositions was performed by forming a largely aqueous tank mix of the indicated composition, and applying the same using a tractor mounted CO₂ pressurized (approx. 20-24 psi pressure) boom-type sprayer having directed nozzles and having an height of approx. 18 inches above the bed of the rice crop being treated.

The results reported on the table are evaluations which were performed visual evaluation of like-sized areas of each of the treated rice plots which like-sized areas were randomly selected. The Table reports both the % control or the degree of control of undesired vegetative growth of the identified weeds in the evaluated areas of each of the rice crops, and also reports the relative improvement in control of the said undesired vegetative growth as compared to the efficacy of the C2 composition.

The observed and results reported results are surprising and would be unexpected by a skilled artisan.

The benefits of this discovery are real and are several. As is readily seen from the foregoing, the treatment regimens E1 through E6 all exhibited significantly improved efficacy in the control of the identified weeds, as compared to the two comparative treatment regimens, C1 and C2. The degree of control of the Sesbania hemp (Sesbania exaltata) and Indian Joint vetch (Aeschynomene indica)was particularly and effective by the utilization of sulfonylurea based herbicide treatment preparations in treatment regimens as described above. It is contemplated that the use of sulfonylurea based herbicide treatment preparations may provide similarly effective and surprisingly good control of other species of unwanted vegetative growth. It was also observed that sulfonylurea based herbicide treatment preparations did not deleteriously affect the crop of the rice varieties tested.

It is also readily understood from reviewing the results reported on Table 1 that the compositions according to each of Examples E1 through E6, each of which included at least one application of P concurrently with NP to the rice crop achieved startling improvements in efficacy of the undesired vegetative growth. Comparing these results to those reported for C1 and C2, evidence is shown that the combination of P with NP attained superior results relative to an untreated control, or application solely of CMD.

### Example II

A number of separate, uniformly sized rice crop areas were used to evaluate the efficacy of certain treatment regimens for the control of undesired vegetative growth in a rice crop planted with Clearfield variety rice. The identity of the constituents and timings of application of one regimen which excluded the use of sulfonylurea based herbicide treatment preparations, and six regiments which included the application of at least one sulfonylurea based herbicide treatment preparation is described on the following Table 2.

TABLE 2

| | | % control of undesired vegetative growth | | | |
|---|---|---|---|---|---|
| | | (viz., Sesbania hemp) evaluated | | | |
| | | 14, 20, 30 and 41 days after first application | | | |
| | | of herbicidal treatment preparation | | | |
| | | Sesbania | Sesbania | Sesbania | Sesbania |
| | | hemp at | hemp at | hemp at | hemp at |
| | Treatment Regimen | 14 days | 20 days | 30 days | 41 days |
| C3 | no treatment | 0% | 0% | 0% | 0% |
| C4 | single application of NP (4 fl. oz./acre) with 1% v/v COC applied | 10% | 47.5% | 57.5% | 47.5% |
| | VE Post; | | | | |
| | subsequently, single application of NP (4 fl. oz./acre) with 1% v/v | | | | |
| | COC applied ME Post | | | | |
| E7 | single application of NP (4 fl. oz./acre) with 1% v/v COC applied | 12.5% | 90% | 95% | 95% |
| | VE Post; | | | | |
| | subsequently, single application of NP (4 fl. oz./acre) with P | | | | |
| | (0.67 oz./acre) and with 1% v/v COC applied ME Post | | | | |

Application of the above treatment compositions recited on Table 2 was performed by forming a largely aqueous mix of the indicated composition, and applying the same using a backpack mounted pressurized (approx. 24-28 psi pressure) flatfan nozzled sprayer at height of approx. 18 inches above the bed of the rice crop being treated.

It is significant to note that the treatment composition according to the invention, viz., E7 of Table 2 provided unexpectedly superior control of Sesbania hemp as compared to the comparative composition C4 which included only NP but excluded P, and especially when compared to the untreated control C3. Advantageously the treatment regimens of Table 2 also ultimately yielded strikingly different harvested crop yields, which are reported on the following Table 3:

TABLE 3

| | Harvested |
|---|---|
| | Rice yield |
| Crop/Treatment Regimen | (bushels/acre) |
| Clearfield Rice/C4 | 94 |
| Clearfield Rice/E7 | 188 |

The harvested yields of the rice crops treated according to treatment regimens C4 and E7 illustrate that the effective crop yield (mass) of rice was more than 100% greater with the areas of Clearfield variety rice crops treated with regimen E7 as compared to C4, which were otherwise subjected to identical growing conditions in Arkansas, USA.

1. Improved agricultural processes for the improved cultivation of crops of rice varieties, preferably rice varieties modified to be tolerant to imparted with resistance to imidazolinone type herbicides wherein the crops are treated to control undesired vegetative growth using a sulfonylurea based herbicidal composition to provide improved herbicidal efficacy, especially wherein the undesired vegetative growth are one or more of: of Sesbania hemp (Sesbania exaltata), Indian Joint vetch (Aeschynomene indica), and Alligator weed (Alternanthera philoxeroides).

2. Improved agricultural processes according to claim 1 wherein the sulfonylurea herbicidal composition is a halosulfuron methyl represented by the structure: 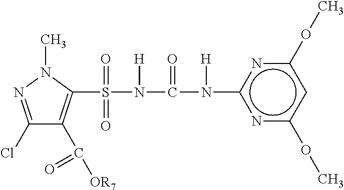
wherein R₇ is hydrogen or is a C₁-C₆ straight or branched alkyl group, preferably is, methyl or ethyl, especially preferably is methyl.

3. Improved agricultural processes according to claim 2 wherein the halosulfuron methyl compound is methyl-3-chloro-5-(4,6-dimethoxypyrimidin-2-ylcarbamoylsulfamoyl)-1-methylpyrazole-4-carboxylate.

4. Treatment regimens for the herbicidal treatment of crops of rice varieties, preferably rice varieties modified to be tolerant to imparted with resistance to imidazolinone type herbicides in order to provide improved control and/or improved eradication of one or more of: of Sesbania hemp (Sesbania exaltata), Indian Joint vetch (Aeschynomene indica), and Alligator weed (Alternanthera philoxeroides) within the planted rice crop, comprising the application of a sulfonylurea based herbicidal composition to provide improved herbicidal efficacy.

5. Treatment regimens according to claim 4 wherein the sulfonylurea based herbicidal composition is a halosulfuron methyl represented by the structure: 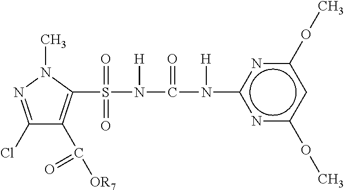
wherein R₇ is hydrogen or is a C₁-C₆ straight or branched alkyl group, preferably is hydrogen, methyl or ethyl, or acid form thereof.

6. Treatment regimens according to claim 4 wherein the halosulfuron methyl compound is methyl-3-chloro-5-(4,6-dimethoxypyrimidin-2-ylcarbamoylsulfamoyl)-1-methylpyrazole-4-carboxylate

7. Herbicidal compositions useful in the treatment of crops of rice, preferably rice varieties modified to be tolerant to imparted with resistance to imidazolinone type herbicides which are useful in the agricultural processes according claim 1 or in the novel treatment regimens according to claim 4, which herbicidal compositions comprise a sulfonylurea based herbicidal composition.

8. Herbicidal compositions according to claim 8, wherein the sulfonylurea based herbicidal composition is a halosulfuron methyl represented by the structure: 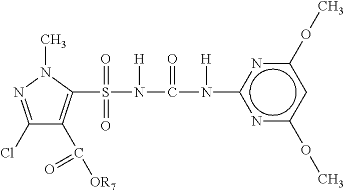
wherein R₇ is hydrogen or is a C₁-C₆ straight or branched alkyl group, preferably is hydrogen, methyl or ethyl, or acid form thereof

9. An improved agricultural processes for the improved cultivation of crops of rice varieties, preferably rice varieties modified to be tolerant to imparted with resistance to imidazolinone type herbicides wherein the crops are treated to control undesired vegetative growth using both a sulfonylurea based herbicidal composition with an imidazoline based herbicidal composition to provide synergistically improved herbicidal efficacy, especially wherein the undesired vegetative growth are one or more of: of Sesbania hemp (Sesbania exaltata), Indian Joint vetch (Aeschynomene indica), and Alligator weed (Alternanthera philoxeroides).

10. Herbicidal compositions useful in the treatment of crops of rice, preferably rice varieties modified to be tolerant to imparted with resistance to imidazolinone type herbicides which are useful in the agricultural processes according claim 9 which herbicidal compositions comprise both a sulfonylurea based herbicidal composition and an imidazolinone based herbicidal composition.
